(19) United States
(12) Patent Application Publication
(10) Pub. No.: US 2015/0116278 A1
(43) Pub. Date: Apr. 30, 2015

(54) ELECTRONIC APPARATUS AND COORDINATE CORRECTING METHOD

(71) Applicant: Kabushiki Kaisha Toshiba, Tokyo (JP)

(72) Inventors: Dai Oyama, Tachikawa-shi (JP); Isao Ohba, Tokyo (JP); Saori Michihata, Sagamihara-shi (JP); Hiromichi Suzuki, Koganei-shi (JP)

(21) Appl. No.: 14/325,890

(22) Filed: Jul. 8, 2014

(30) Foreign Application Priority Data
Oct. 31, 2013 (JP) 2013-226972

(51) Int. Cl. G06F 3/041

(52) U.S. Cl. CPC G06F 3/0418; G06F 3/0412
USPC 345/178

(57) ABSTRACT

According to one embodiment, an electronic apparatus comprises a detector and a processor. The detector is configured to chronologically detect coordinates of positions sequentially indicated by an indicator on a detection surface. The processor is configured to determine a level of noise based on the coordinates, and to correct the coordinates using a correction strength value corresponding to the level of noise.

### CROSS-REFERENCE TO RELATED APPLICATIONS

This application is based upon and claims the benefit of priority from Japanese Patent Application No. 2013-226972, filed Oct. 31, 2013, the entire contents of which are incorporated herein by reference.

### FIELD

Embodiments described herein relate generally to an electronic apparatus and a coordinate correcting method.

### BACKGROUND

Electronic apparatuses with a device configured to detect the position indicated by a user on a detection surface using, for example, a pen-type indicator are available. Such devices are called, for example, digitizers.

Deviation may occur between the position indicated by an indicator and the coordinates detected by a digitizer, because of the noise generated by various components of an electronic apparatus. Since the noise varies depending upon the mount position of the circuit and/or the state of use of the electronic apparatus, it is difficult to correct the noise by uniform correction.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of the appearance of an electronic apparatus according to an embodiment;

FIG. 2 is a block diagram showing the essential structure of the electronic apparatus of the embodiment;

FIG. 3 is a block diagram showing the functionality of the electronic apparatus of the embodiment;

FIG. 4 is a graph for explaining a noise level determining method and a coordinate correcting method employed in the embodiment; and

FIG. 5 is a flowchart for explaining the operation of a digitizer controller employed in the embodiment.

### DETAILED DESCRIPTION

Various embodiments will be described hereinafter with reference to the accompanying drawings.

In general, according to one embodiment, an electronic apparatus comprises a detector and a processor. The detector is configured to chronologically detect coordinates of positions sequentially indicated by an indicator on a detection surface. The processor is configured to determine a level of noise based on the coordinates, and to correct the coordinates using a correction strength value corresponding to the level of noise.

In the description below, like reference numbers denote like elements, and duplication of explanation is avoided.

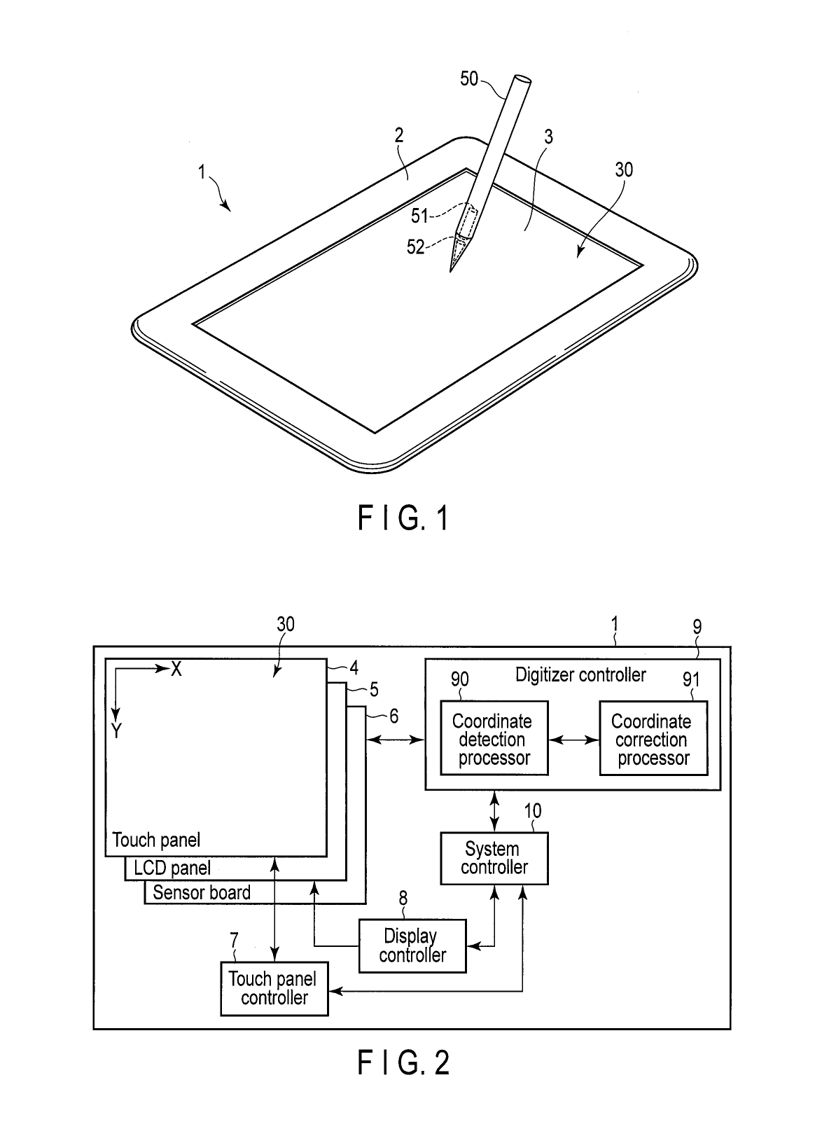

FIG. 1 is a perspective view of the appearance of an electronic apparatus 1 according to an embodiment. FIG. 2 is a block diagram showing the essential structure of the electronic apparatus 1.

As shown in FIG. 1, the electronic apparatus 1 is a tablet terminal including a flat casing 2. The casing 2 includes a detection surface 30 for detecting the position indicated by an indicator 50 or a user's finger. The detection surface 30 also serves as a display surface for still and video images.

As shown in FIG. 2, the electronic apparatus 1 includes a touch panel 4, a liquid crystal display (LCD) panel 5, a sensor board 6, a touch panel controller 7, a display controller 8, a digitizer controller 9 and a system controller 10, etc.

When part, such as a hand H or a finger, of the body of the user touches the touch panel 4, the panel 4 outputs a detection signal corresponding to the contact position to the touch panel controller 7. As the touch panel 4, a touch panel of, for example, an electrostatic capacitance type can be used.

The LCD panel 5 includes a backlight unit with a light source and a light guiding plate, a liquid crystal module for controlling the passing of light emitted from the backlight unit, and a plurality of optical sheets, such as a prism sheet and a deflection sheet. By controlling the transmission of light from the backlight unit through the liquid crystal module, an arbitrary image can be displayed on the detection surface 30.

The sensor board 6 outputs a detection signal corresponding to the position on the detection surface 30 indicated by the tip of the indicator 50.

The touch panel 4, the LCD panel 5 and the sensor board 6 are formed rectangular and flat to have the same size, and are stacked in this order. Namely, the detection surface 30 is also rectangular. In the embodiment, an X axis is defined as a line parallel to the short side of the detection surface 30, and a Y axis is defined as a line parallel to the long side of the detection surface 30.

The touch panel controller 7 calculates the X- and Y-coordinates of the position on the detection surface 8 touched by, for example, a user's finger, based on the signal output from the touch panel 4, and outputs the calculated data to the system controller 10.

The display controller 8 controls the LCD panel 5 to display various still and video images.

In the embodiment, the sensor board 6 provides a digitizer of an electromagnetic induction type, along with the digitizer controller 9. Namely, the sensor board 6 includes a plurality of loop coils arranged along the X axis direction, and a plurality of loop coils arranged along the Y axis direction.

The indicator 50 has a shape like a pen. The indicator 50 contains a resonance circuit 51 functioning as a magnetic field source, and a pen pressure sensor 52. The resonance circuit 51 includes a coil, a capacitor, etc. The pen pressure sensor 52 detects the pressure applied to the pen tip of the indicator 50.

When a current has been supplied to each loop coil C of the sensor board 6, each loop coil C generates a magnetic field spreading all over the detection surface 30. Upon receiving the magnetic field, an induction voltage occurs in the resonance circuit 51 to accumulate energy therein. When the supply of the current to each loop coil is stopped, a magnetic field is generated from the resonance circuit 51 by the energy accumulated therein. Because of this magnetic field, an induction voltage occurs in each of the loop coils positioned near the indicator 50. The induction voltage having occurred in each loop coil is input as a detection signal to the digitizer controller 9, after being amplified by an amplification circuit.

The resonance circuit 51 is configured to vary its resonance frequency in accordance with the pen pressure detected by the pen-pressure sensor 52.

The system controller 10 includes a central processing unit (CPU), and causes the CPU to execute an operating system (OS) and computer programs associated with applications to thereby realize various functions.

The digitizer controller 9 includes a coordinate detection processor 90 and a coordinate correction processor 91.

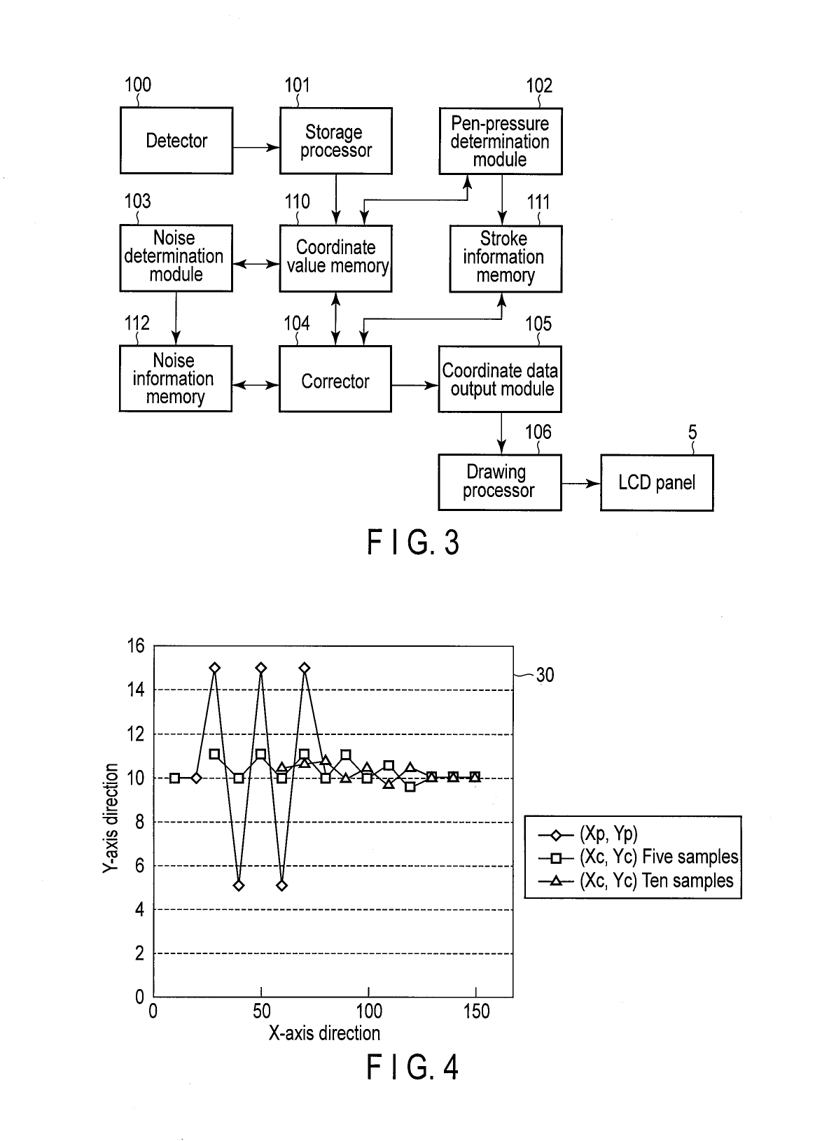

Referring now to the block diagram of FIG. 3, the function of the electronic apparatus 1 associated with coordinate detection using the digitizer will be described. The coordinate detection processor 90 functions as a detector 100 and a storage processor 101 by executing a computer program for coordinate detection. The coordinate correction processor 91 functions as a pen-pressure determination module 102, a noise determination module 103, a correction module 104 and a coordinate data output module 105 by executing a computer program for coordinate correction. A drawing processor 106 is realized by the system controller 10. A coordinate value memory 110, a stroke information memory 111 and a noise information memory 112 are internal memories incorporated in, for example, the digitizer controller 9.

The detector 100 chronologically detects the X- and Y-coordinates of the positions sequentially indicated by the indicator 50 on the detection surface 30, based on the signal received from the sensor board 6. The X- and Y-coordinates detected by the detector 100 will hereinafter be referred to as coordinates (Xp, Yp). Further, the detector 100 determines the above-mentioned resonance frequency based on a change in the detection signal of each loop coil of the sensor board 6, and generates a pen-pressure value P indicating the magnitude of a pen pressure, based on the determined resonance frequency.

The storage processor 101 stores, in the coordinate value memory 110, the coordinates (Xp, Yp) and the pen-pressure value P detected by the detector 100.

The pen-pressure determination module 102 determines whether there is a pen pressure, based on the pen-pressure value stored in the coordinate value memory 110. The pen-pressure determination module 102 also determines whether the present stage is a stroke stage or a stroke end stage, based on the pen-pressure value P stored in the coordinate value memory 110. “Stroke” means a sequence of movement made from the time when the tip of the indicator 50 touches the detection surface 30 to the time when it is detached therefrom. The pen-pressure determination module 102 stores, in the stroke information memory 111, a determination result indicating whether a pen pressure exists, and a determination result indicating whether the present stage is a stroke stage or a stroke end stage. The stroke information memory 111 includes a flag F1 indicating existence/non-existence of the pen pressure, and a flag F2 indicating the stroke stage or stroke end stage. By turning on/off these flags F1 and F2, the pen-pressure determination module 102 can store each determination result.

The noise determination module 103 determines the level of the noise resulting from, for example, the influence of the peripheral circuit of the sensor board 6, based on the coordinates (Xp, Yp) detected by the detector 100. The noise determination module 103 carries out this determination in association with each pair of the coordinates (Xp, Yp) detected chronologically, and stores the determined levels in the noise information member 112.

The corrector 104 corrects the coordinates detected by the detector 100 to generate corrected coordinates (Xc, Yc), using a correction strength value corresponding to the noise level determined by the noise determination module 103 in association with the coordinates. More specifically, the corrector 104 increases the correction strength value associated with the coordinates (Xp, Yp) newly detected by the detector 100, if the noise level associated with these coordinates (Xp, Yp) exceeds the maximum noise level associated with the coordinates (Xp, Yp) which are included in the same stroke as that corresponding to the newly detected coordinates (Xp, Yp) and were detected before the same. After thus increasing the correction strength value, the corrector 104 again corrects, using the increased correction strength value, each pair of coordinates (Xp, Yp) detected before the newly detected coordinates (Xp, Yp), thereby regenerating corrected coordinates (Xc, Yc) for each pair of coordinates (Xp, Yp). Furthermore, the corrector 104 uses a maximum correction strength value that was used for the correction of the coordinates (Xp, Yp) included in a certain stroke (first stroke), as an initial correction strength value for the correction of a subsequent stroke (second stroke).

The coordinate data output module 105 outputs, to the drawing processor 106, coordinate data including the corrected coordinates (Xc, Yc) generated by the corrector 104, and pen-pressure values P corresponding to the corrected coordinates (Xc, Yc).

The drawing processor 106 generates drawing data used to display the corrected coordinates (Xc, Yc) included in the coordinate data output from the coordinate data output module 105, and causes the LCD panel 5 to display the drawing data.

A description will now be given of an example of a noise level determination method employed in the noise determination module 103, and an example of a correction method employed in the corrector 104.

FIG. 4 shows a state in which coordinates (Xp, Yp) corresponding to one stroke before correction, and two types of corrected coordinates (Xc, Yc) obtained by correcting the coordinates (Xp, Yp), are displayed on the detection surface 30. The scales along the X axis and the Y axis assume arbitrary values.

In FIG. 4, rhombic marks represent the points indicated by the coordinates (Xp, Yp) chronologically detected, and the detection cycle is, for example, several tens Hz. The stroke corresponding to the coordinates (Xp, Yp) is obtained by linearly moving the indicator 50 along the X axis direction. However, by the influence of noise, this stroke sometimes greatly vibrates along the Y axis direction. Since the detection interval of adjacent marks is several tens milliseconds, when a user moves the indicator 50 in a traveling direction (X axis direction), such an acute angle movement cannot occur.

In light of the above, the noise determination module 103 determines the noise level, based on the Y-axis directional vibration width W of the points (indicated by the coordinates (Xp, Yp)) that are distributed adjacent to each other in the traveling direction. The traveling direction can be set from, for example, an approximate straight line obtained by connecting a plurality of points indicated by pairs of coordinates (Xp, Yp) detected immediately before the detection of the coordinates (Xp, Yp) as noise level determination targets. The width W can be set as the distance between the point indicated by the coordinates (Xp, Yp) of the noise level determination targets and the approximate straight line. The noise determination module 103 determines the noise level by comparing the width W with n predetermined thresholds Ws1 to Wsn. For instance, if n=3, the noise determination module 103 determines that the noise level is 1 if W<Ws1, is 2 if Ws1≦W<Ws2, is 3 if Ws2≦W<Ws3, and is 4 if Ws3≦W.

In the embodiment, the correction by the corrector 104 is a moving average processing using the coordinates (Xp, Yp) as the correction targets, and one or more pairs of coordinates (Xp, Yp) detected immediately before the correction target coordinates. The moving average processing may be either a simple moving average processing or a weighted moving average processing. In the following description, the number of pairs of coordinates (Xp, Yp) used for the moving average processing will be referred to as the number of samples. The number of samples corresponds to the above-mentioned correction strength value. The corrector 104 calculates the corrected coordinate Xc by performing the moving average processing on a predetermined number of samples of coordinates Xp including the correction target coordinate Xp, and calculates the corrected coordinate Yc by performing the moving average processing on a predetermined number of samples of coordinates Yp including the correction target coordinate Yp.

In FIG. 4, square marks represent the points indicated by the corrected coordinates (Xc, Yc) obtained by correcting 5 samples of coordinates (Xp, Yp), and triangular marks represent the points indicated by the corrected coordinates (Xc, Yc) obtained by correcting 10 samples of coordinates (Xp, Yp). It is understood from this figure that the larger the number of samples, the smoother the segments associated with a stroke, namely, the smaller the adverse influence of noise.

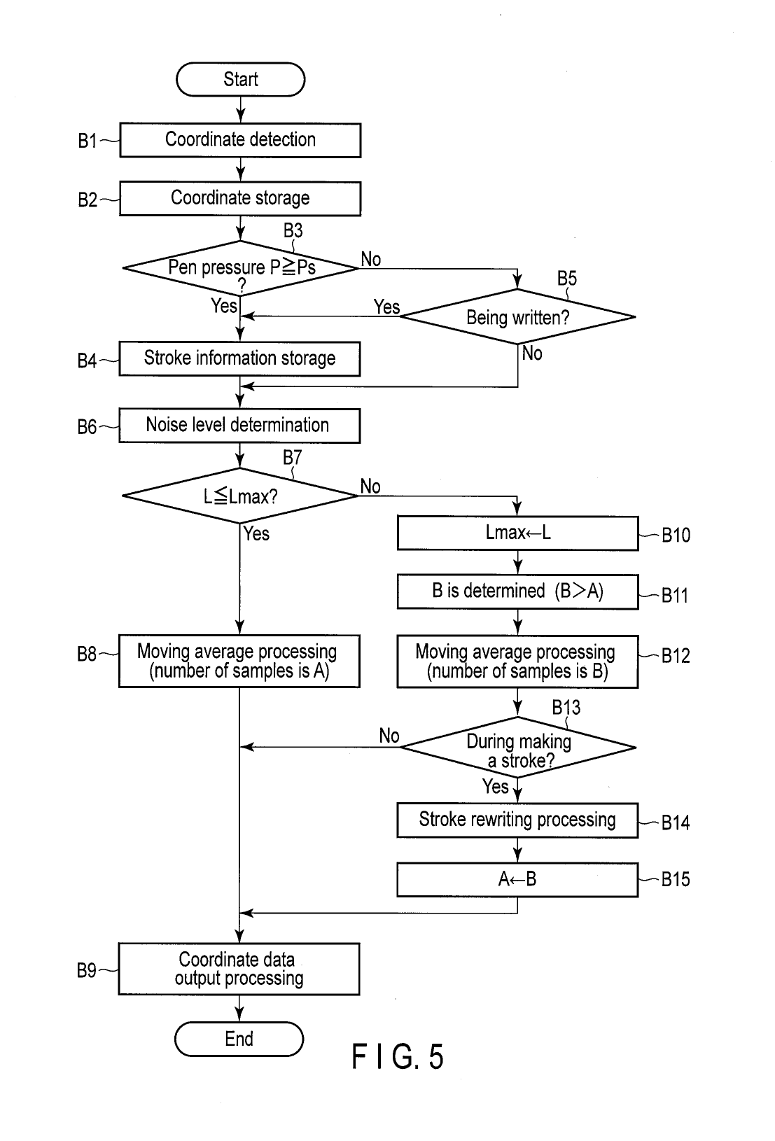

A sequence of processing realized by the coordinate detection processor 90 and the coordinate correction processor 91 will be described. When an input function using a digitizer has become necessary during the operation of the OS or application, the system controller 10 supplies the digitizer controller 9 with a command for instructing the controller 9 to turn on the input function using the digitizer. Using this command as a trigger, the digitizer controller 9 iteratively executes the processing shown in FIG. 5 at the above-mentioned detection cycles.

After turning on the input function using the digitizer, the digitizer controller 9 initializes the coordinate value memory 110. Further, the digitizer controller 9 generates, in the noise information memory 112, a variable L for storing a noise level, thereby initializing the variable L (e.g., sets L to “1” as the lowest level), and generates, in the noise information memory 112, a variable Lmax for storing a maximum noise level, thereby initializing the variable Lmax (e.g., sets Lmax to the lowest level). Also, the digitizer controller 9 generates, in the noise information memory 112, variables A and B indicating the number of samples for the moving average processing and used at the time of correction, thereby initializing the variables A and B (e.g., set them to “1” as the lowest level). In addition, the digitizer controller 9 generates the above-mentioned flags F1 and F2 in the stroke information memory 111, and turns off them.

In the flowchart, firstly, the detector 100 drives the sensor board 6 to detect the coordinates (Xp, Yp) and the pen-pressure value P (block B1). Subsequently, the storage processor 101 stores, in the coordinate value memory 110, the coordinates (Xp, Yp) and the pen-pressure value P detected in block B1 (block B2). During the time when the operations shown in the flowchart are periodically executed, the coordinates (Xp, Yp) and pen-pressure value P chronologically detected are sequentially stored in the coordinate value memory 110. Accordingly, the storage processor 101 stores the coordinates (Xp, Yp) and the pen-pressure values P in the coordinate value memory 110 such that the order of detection of the respective sets of coordinates (Xp, Yp) and the pen-pressure values P is clear.

After block B2, the pen-pressure determination module 102 compares the pen pressure value P stored in the coordinate value memory 110 in block B2 with a threshold Ps to determine whether there is a pen pressure (block B3). If the pen pressure value P is not lower than the threshold Ps (P≧Ps) (Yes in block B3), the pen-pressure determination module 102 stores the determination result in the stroke information memory 111 (block B4). In block B4, the pen-pressure determination module 102 turns on the flag F1 (indicating that there is a pen pressure) and the flag F2 (indicating that a stroke is being made).

If in block B3, the pen pressure value P is less than the threshold Ps (P<Ps) (No in block B3), the pen-pressure determination module 102 determines whether writing is being made (block B5). The state in which writing is being made indicates a state in which the indicator 50 touches the detection surface 30 at least one time after the input function using the digitizer is turned on. If the pen pressure value P exceeds the threshold Ps at least one time after the input function using the digitizer is turned on (Yes in block B5), the pen-pressure determination module 102 determines that writing is being made. In this case (Yes in block B5), the pen-pressure determination module 102 proceeds to block B4, where it turns off the flag F1 (no pen pressure) and the flag F2 (stroke end).

In contrast, if in block B5, it is determined that no writing is being made (No in block B5), the pen-pressure determination module 102 skips block B4 and proceeds to block B6. Namely, the flags F1 and F2 are kept off as in the initial state.

After block B4, of after it is determined in block B5 that no writing is being made, the noise determination module 103 determines the level of noise based on the coordinates (Xp, Yp) stored in the coordinate value memory 110 (block B6). This determination is performed based on the Y-axis directional vibration width W of the points (indicated by the coordinates (Xp, Yp)) that are distributed adjacent to each other in the traveling direction, as is described above. The noise determination module 103 stores the determined noise level as the variable L in the noise information memory 112.

After block B6, the corrector 104 compares the variable L with the variable Lmax (block B7). If the variable L is not greater than the variable Lmax (L≧Lmax) (Yes in block B7), the corrector 104 executes a moving average processing on the coordinates (Xp, Yp) stored in the coordinate value memory 110, using the number of samples indicated by the variable A, thereby generating the corrected coordinates (Xc, Yc) of the coordinates (Xp, Yp) stored in block B2 of the current loop (block B8).

Thereafter, the coordinate data output module 105 outputs, to the system controller 10, coordinate data that includes the corrected coordinates (Xc, Yc) generated in block B8, and the current flag F1 value (block B9). In the system controller 10, the drawing processor 106 sequentially stores, in the internal memory of the system controller 10, the coordinate data input after the input function using the digitizer is turned on. These coordinate data items are grouped for the respective strokes. Coordinate data corresponding to one stroke, which is included in the coordinate data chronologically input to the system controller 10, is obtained during the time from the switching of the flag F1 from OFF to ON to the switching of the flag F1 from ON to OFF.

The drawing processor 106 generates drawing data whenever coordinate data is stored in the above-mentioned internal memory, and displays an image corresponding to this drawing data on the LCD panel 5. For instance, the drawing data indicates a line segment obtained by connecting, in each stroke, the corrected coordinates (Xc, Yc) indicated by the coordinate data stored in the internal memory. The drawing data may include a pointer that shows the input position of the indicator 50 in the position indicated by the newest corrected coordinates (Xc, Yc).

If in block B7, the variable L is greater than the variable Lmax (L>Lmax) (No in block B7), the corrector 104 updates the variable Lmax to the variable L (block B10). Further, the corrector 104 determines the number of samples corresponding to the variable L (=Lmax), and stores the determined value as the variable B (block B11). The number of samples corresponding to the variable L can be determined using a table that shows the relationship between the noise level and the number of samples. In this table, for example, a larger number of samples are set for a higher noise level (variable L). Namely, immediately after the execution of block B11, variable B>variable A.

After block B11, the corrector 104 executes a moving average processing on the coordinates (Xp, Yp) stored in the coordinate value memory 110, using the number of samples corresponding to the variable B, thereby generating the corrected coordinates (Xc, Yc) of the coordinates (Xp, Yp) stored in block B2 of the current loop (block B12).

After block B12, the corrector 104 refers to the flag F2 to determine whether it indicates that a stroke is being made (block B13). If the flag F2 is in the OFF state, i.e., indicates a stroke end (No in block B13), the program proceeds to block B9, where the coordinate data output module 105 outputs, to the system controller 10, coordinate data including the corrected coordinates (Xc, Yc) generated in block B8 and the current flag F1 value.

If the flag F2 is in the ON state (i.e., a stroke is being made) (Yes in block B13), the corrector 104 executes stroke rewriting processing (block B14). The stroke rewriting processing is performed when the number of samples for the moving average processing has been increased during making a stroke. In this processing, each pair of coordinates (Xp, Yp), which is included in the stroke and has been detected before the coordinates (Xp, Yp) of the stroke corrected in block B12 of the current loop, is re-corrected using the increased number of samples to thereby regenerate corrected coordinates (Xc, Yc) of each pair of coordinates (Xp, Yp). More specifically, the corrector 104 considers that a group of coordinates up to the newest coordinates (Xp, Yp), which is stored in the coordinate value memory 110 and has pen-pressure values P continuously exceeding the threshold Ps, is included in the stroke, and regenerates corrected coordinates (Xc, Yc) by performing a moving average processing on each pair of coordinates (Xp, Yp), using the variable B as the number of samples.

After the block B14, the corrector 104 updates the variable A with the variable B (block B15). As a result, the number of samples corresponding to the current variable Lmax is set as that for subsequent correction. For instance, assuming that first and second strokes are sequentially written, the value stored as the variable A when the first stroke has been written indicates the number of samples corresponding to the maximum noise level of the first stroke. When the flag F2 is in the OFF state (during hovering), the variable A is not updated, and hence the initial value of the number of samples for correcting the second stroke is the variable A, i.e., the maximum number of samples used for correcting the first stroke.

After block B15, the program proceeds to block B9. In block B9, the coordinate data output module 105 outputs, to the system controller 10, coordinate data items that include corrected coordinates (Xc, Yc) corresponding to one stroke and obtained by adding each pair of coordinates (Xc, Yc) regenerated in block B14 to the corrected coordinates (Xc, Yc) generated in block B12. The flag F1 contained in each of the coordinate data items is in the ON state. Using the coordinate data items corresponding to one stroke, the drawing processor 106 updates the coordinate data items corresponding to the stroke and stored in the internal memory. Further, the drawing processor 106 generates drawing data based on the updated coordinate data items stored in the internal memory, and displays, on the LCD panel 5, the image based on the drawing data. As a result, the line segment corresponding to the currently written stroke already displayed on the LCD panel 5 is replaced with the line segment corresponding to each pair of coordinates (Xc, Yc) regenerated in block B14.

In block B9, the sequence of operations shown in the flowchart of FIG. 5 is completed, and the program returns to block B1 to resume performing the operations. If the input function using the digitizer has become unnecessary during the operation of the OS or application, the system controller 10 supplies the digitizer controller 9 with a command for instructing turn-off of the input function using the digitizer. Upon receiving the command, the digitizer controller 9 stops the iterative executions of the operations shown in the flowchart.

The electronic apparatus 1 of the embodiment provides the following advantages:

The electronic apparatus 1 corrects coordinates (Xp, Yp) while determining a noise level based on chronologically detected coordinates (Xp, Yp) and dynamically changing a correction strength value (the number of samples) in accordance with the detected noise level. Accordingly, the deviation between the position indicated by the indicator 50 and the coordinates detected by the digitizer, which will occur due to noise, can be accurately corrected.

When the electronic apparatus 1 has changed the correction strength value for coordinates (Xp, Yp) newly detected during making a stroke, the coordinates (Xp, Yp) detected in the stroke before the newly detected ones (Xp, Yp) are re-corrected using the changed correction strength value. As a result, the correction strength value used for each pair of coordinates (Xp, Yp) included in the same stroke can be unified. For instance, when a line segment obtained by connecting the input coordinates of a stroke is displayed, if the correction strength value is changed during making the stroke, the degree of vibration of the resultant line segment will change in accordance with the correction strength value change, whereby the continuity of the stroke may be degraded. In contrast, if the correction strength value is unified in each stroke as in the embodiment, the input coordinates of each stroke can be maintained in continuity.

The electronic apparatus 1 uses the maximum correction strength value used for correcting the coordinates of one stroke, as the initial number of samples for a subsequent stroke. As a result, the input sensitivity of two continuous written strokes can be unified.

Various effects other than the above can be obtained from the structure disclosed in the embodiment.

[Modifications]

Some modifications will be described.

The embodiment employs a tablet terminal as the electronic apparatus 1. However, the above-described mechanism is also applicable to another type of electronic apparatus, such as a notebook PC or a smartphone.

The computer programs for realizing the detector 100, the storage processor 101, the pen-pressure determination module 102, the noise determination module 103, the corrector 104 and the coordinate data output module 105 may be provided by beforehand installing them in the electronic apparatus, or by recording them in a computer-readable storage medium. Alternatively, the computer programs may be downloaded to the electronic apparatus 1 via a network. Yet alternatively, the elements 100 to 105 may be realized by, for example, dedicated ICs.

The orders of processing associated with blocks B1 to B15 are not always limited to those shown in the flowchart of FIG. 5, but may be changed arbitrarily.

In the embodiment, the maximum number of samples that was used to correct the coordinates (Xp, Yp) of a stroke (first stroke) is used as the initial number of samples for correcting a subsequent stroke (second stroke). However, if the noise level of the second stroke is lower than the level corresponding to the initial number of samples, the number of samples may be reduced after writing the second stroke, and the reduced number of states be used to re-correct and re-draw the coordinates of the second stroke.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a detector configured to chronologically detect coordinates of positions sequentially indicated by an indicator on a detection surface;
a processor configured to determine a level of noise based on the coordinates, and to correct the coordinates using a correction strength value corresponding to the level of noise.

2. The electronic apparatus of claim 1, wherein
the processor is configured to determine the level of noise in association with each of the coordinates included in a stroke and chronologically detected by the detector, and to increase the correction strength value for a newly detected coordinate included in the stroke, when the level of noise associated with the newly detected coordinate exceeds a maximum level of noise associated with a coordinate in the stroke detected before the newly detected coordinate.

3. The electronic apparatus of claim 2, wherein the processor is configured to re-correct the coordinate using the increased correction strength value, when the correction strength value for the newly detected coordinate is increased.

4. The electronic apparatus of claim 2, wherein the processor is configured to use a maximum correction strength value used to correct a coordinate included in a first stroke, as an initial correction strength value for correcting a second stroke made after the first stroke.

5. The electronic apparatus of claim 1, wherein the processor is configured to determine the level of noise based on a vibration width of points indicated by the coordinates chronologically detected by the detector, the variation width intersecting a reference direction.

6. The electronic apparatus of claim 1, wherein
a correction by the processor comprises a moving average processing of the chronologically detected coordinates; and
the correction strength value corresponds to a number of samples in the moving average processing.

7. A coordinate correction method in an electronic device comprising:
chronologically detecting coordinates of positions sequentially indicated by an indicator on a detection surface;
determining a level of noise based on the coordinates; and
correcting the coordinates, using a correction strength value corresponding to the level of noise.

8. The coordinate correction method of claim 7, further comprising:
determining the level of noise in association with each of the coordinates included in a stroke and chronologically detected; and
increasing the correction strength value for a newly detected coordinate included in the stroke, when the level of noise associated with the newly detected coordinate exceeds a maximum level of noise associated with a coordinate in the stroke detected before the newly detected coordinate.

9. The coordinate correction method of claim 8, further comprising re-correcting, after the increasing the correction strength value, the coordinate, using the increased correction strength value.

10. The coordinate correction method of claim 8, further comprising setting a maximum correction strength value used to correct a coordinate included in the first stroke, as an initial correction strength value for correcting a second stroke made after the first stroke.

11. The coordinate correction method of claim 7, wherein the determining the level of noise includes determining the level of noise based on a vibration width of points indicated by chronologically detected coordinates, the variation width intersecting a reference direction.

12. The coordinate correction method of claim 7, wherein the correcting the chronologically detected coordinates comprises a moving average processing of the chronologically detected coordinates; and
the correction strength value corresponds to a number of samples in the moving average processing.
